(19) United States
(12) Patent Application Publication
(10) Pub. No.: US 2014/0351833 A1
(43) Pub. Date: Nov. 27, 2014

(54) MULTI-COMPUTING ENVIRONMENT OPERATING ON A SINGLE NATIVE OPERATING SYSTEM

(71) Applicants: Min-Lee Teng, Taipei (TW); Ming-Chang Huang, Taoyuan County (TW)

(72) Inventors: Min-Lee Teng, Taipei (TW); Ming-Chang Huang, Taoyuan County (TW)

(21) Appl. No.: 14/287,118

(22) Filed: May 26, 2014

Related U.S. Application Data
(60) Provisional application No. 61/827,592, filed on May 26, 2013.

(51) Int. Cl. G06F 9/54; G06F 3/0481

(52) U.S. Cl. CPC G06F 9/541; G06F 3/0481
USPC 719/328

(57) ABSTRACT

The present invention provides a multi-computing environment for running applications in multiple operating environments without using virtualizations (VM) or a RDP (remote desktop protocol) server, wherein each operating environment comprises a display device and an input device; the multi-computing environment comprises: a first operating environment and a second operating environment; and an operating system, wherein each of a plurality of applications running on top of the system is respectively associated with a tag indicating a corresponding operating environment, wherein the operating system references the tag to associate an execution of each application to a corresponding operating environment of the application respectively.

### BACKGROUND OF THE INVENTION

1. Field of the Invention

The invention relates in general to a computing environment and, in particular, to a multi-computing environment.

2. Description of the Prior Art

Conventional virtual machine (VM) technology can create many independent platforms to take advantages of CPU power of a computer system, however, virtualizations itself will consume lots of resources of the computer system.

Therefore, an efficient and high performance technology to create many parallel processing in a computer system is urgently needed.

### SUMMARY OF THE INVENTION

One object of the present invention is to provide a multi-computing environment in a computer system on a single native operating system for parallel processing without virtualizations.

One embodiment of the present invention is to provide a computing device for running multiple operating environments, the computing device comprises: a first video channel and a first input channel, for connecting to a first display device and a first input device for forming a first operating environment, wherein the first operating environment is used for booting the computing device; a second video channel and a second input channel, for connecting to a second display device and a second input device for forming a second operating environment; and an operating system; wherein when a plurality of applications run on top of the operating system, each of the plurality of applications is respectively associated with a tag indicating a corresponding operating environment selected from a group comprising the first operating environment and the second operating environment, wherein the operating system references the tag to associate an execution of each application to a corresponding operating environment of the application respectively.

In one embodiment, each of the application is respectively associated with a separated tag indicating a corresponding operating environment, wherein the separated tag of each application is changeable, so as to move the application from one operating environment to another operating environment.

One embodiment according to the present invention comprises: a master system comprising a first set of I/O channels, capable of running a first virtual machine; and a subsystem, adapted for connecting the first set of I/O channels of the master system, having a corresponding device diver of the master system, wherein the device diver is linked to the first virtual machine to enable the first virtual machine to use the subsystem through the first set of I/O channels and the device driver independent of the master system.

One embodiment according to the present invention is a virtualization system, comprising: a computing device having a first video output channel and a first input channel, capable of running a first virtual machine; a connecting bus, for connecting the first video output channel and the first input channel of the computing device; an external device, adapted to connected to the connecting bus, for receiving the output signals of the first video output channel and providing input signals to the first input channel of the computing device, wherein the first virtual machine is linked to the external device when the external device is detected by the computing device and dispatched to the first virtual machine.

In one embodiment, a method to run a virtualization system is described, wherein the virtualization system comprises a computing device having a first video output channel and a first input channel, capable of running a first virtual machine; a connecting bus connecting the video output channel and the input channel of the computing device; an external device, adapted to connected to the connecting bus, for receiving the output signals of the first video output channel and providing input signals to the first input channel of the computing device, comprising the steps of: running the first virtual machine; turning on the first video output channel for generating output video signals to the external device when the external device is attached to the connecting bus and detected by the computing device; reading identification and information of the external device; loading a driver for the external device; and dispatching the external device to the first virtual machine.

One object of the present invention is to provide a subsystem for running a first application independently of the master system, wherein the first application has its own dedicated output and input devices to enable true parallel processing.

One embodiment according to the present invention comprises: a master system comprising a first set of I/O channels, capable of running a first application; and a subsystem, adapted for connecting the first set of I/O channels of the master system, having a corresponding device diver of the master system, wherein the device diver is linked to the application to enable the first application to use the subsystem through the first set of I/O channels and the device driver independent of the master system.

One embodiment according to the present invention is a parallel system, comprising: a computing device having a first video output channel and a first input channel, capable of running a first application; a connecting bus, for connecting the first video output channel and the first input channel of the computing device; an external device, adapted to connected to the connecting bus, for receiving the output signals of the first video output channel and providing input signals to the first input channel of the computing device, wherein the first application is linked to the external device when the external device is detected by the computing device and dispatched to the first application.

In one embodiment, a method to run a parallel system is described, wherein the parallel system comprises a computing device having a first video output channel and a first input channel, capable of running a first application; a connecting bus connecting the video output channel and the input channel of the computing device; an external device, adapted to connected to the connecting bus, for receiving the output signals of the first video output channel and providing input signals to the first input channel of the computing device, comprising the steps of: running the first application; turning on the first video output channel for generating output video signals to the external device when the external device is attached to the connecting bus and detected by the computing device; reading identification and information of the external device; loading a driver for the external device; and dispatching the external device to the first application.

The detailed technology and above preferred embodiments implemented for the present invention are described in the following paragraphs accompanying the appended drawings for people skilled in this field to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1A-1B shows a schematic diagram in accordance with one embodiment for running virtual machine on a master system.

FIG. 2A-2B shows a graphic user interface to select a virtual machine;

FIG. 3 shows the master system can provide multiple video channels;

FIG. 4A shows a flow chart to start the VM in accordance with one embodiment;

FIG. 4B-4C shows flow charts to close the VM in accordance with one embodiment;

FIG. 5 shows a mechanical base to sit the master system, and the base has a connector to connect the I/O channels of a master system.

FIG. 6 shows an adaptor which has a first wireless antenna to replace a second wireless antenna in a master system;

FIGS. 7A and 7B shows different ways to connect power supply to the external adaptor;

FIG. 8A-8B shows a schematic diagram in accordance with another embodiment for running application on a master system.

FIG. 9A-9B shows a graphic user interface to select an application in accordance with another embodiment;

FIG. 10A shows a flow chart to start the APP in accordance with another embodiment; and

FIG. 10B-10C shows flow charts to close the APP in accordance with another embodiment;

FIG. 11-13 shows operations on GUI of the mobile phone GUI;

FIG. 14 shows a VM to control the mobile phone with an OS;

FIG. 15-17 shows one embodiment of a multi-computing environment on a single native OS.

FIG. 18-21 shows another embodiment of a multi-computing environment on a single native OS.

FIG. 22 shows another embodiment of a multi-computing environment on a single native OS.

FIG. 23 shows a map for associating PID(s) to TAG(s) indicating which environment an application is running in.

### DETAILED DESCRIPTION OF THE INVENTION

The detailed explanation of the present invention is described as following. The described preferred embodiments are presented for purposes of illustrations and description, and they are not intended to limit the scope of the present invention.

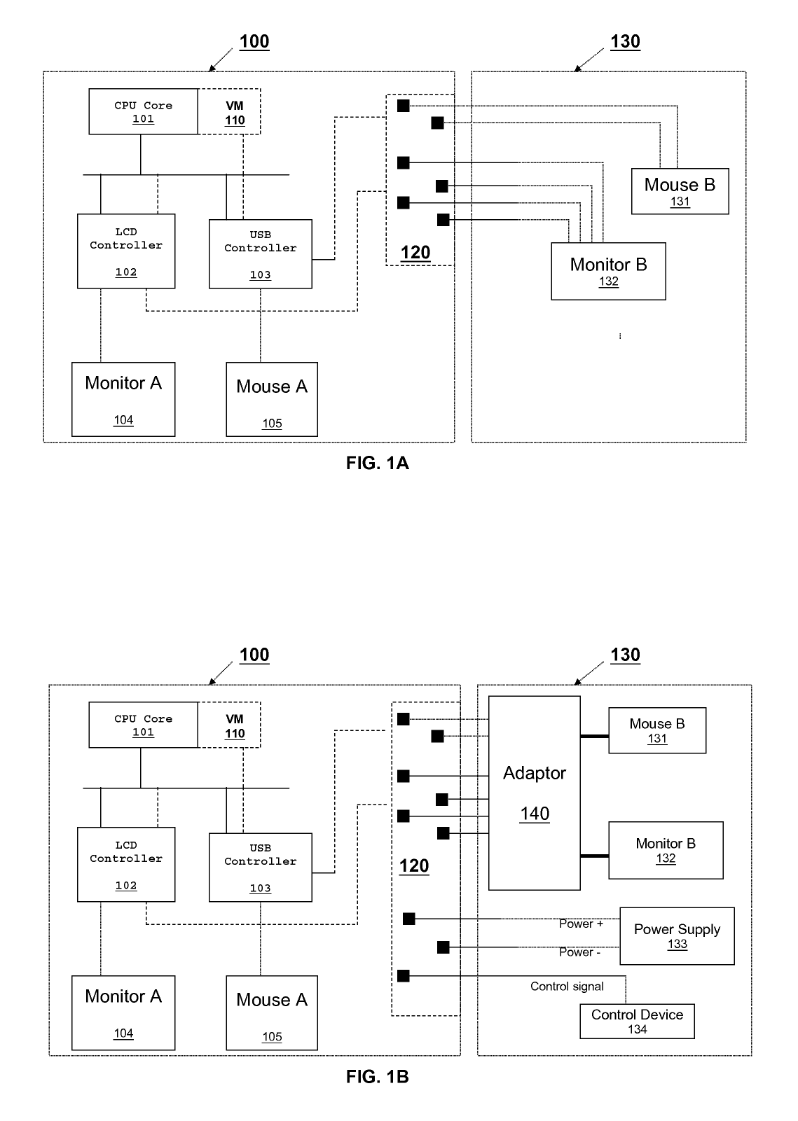

FIG. 1A shows a schematic diagram in accordance with one embodiment for running a virtual machine 110 on an external monitor 132 while a master system 100 is working on its own, which means the virtual machine 110 has its own display or monitor 132 independent of the display or monitor 104 used by the master system 100. In addition, the virtual machine 110 can have its on input device such as a mouse 131 independent of the input devices such as a mouse 105 used by the master system 100 as well. The master system 100 is connected to an external subsystem 130 which includes some I/O devices, such as a mouse 131, a keyboard, a monitor 132, a touch-panel, audio speaker, etc., which provides a great deal of flexibility and adaptability to any environment, such as connecting the subsystem into a desktop, a notebook, a mobile phone or any computing devices capable of running a virtual machine. By doing this way, the I/O devices used by the applications running on the master system 100 can be independent of the I/O devices used by the virtual machine 110; and the I/O devices in the subsystem can be added and configured through loading a device driver corresponding to the subsystem 130 after the master system 100 is power-up and running.

Please continue to refer to FIG. 1A. In one embodiment, the master system 100 has a connector 120 for connecting with the subsystem 130. The mouse 131 is connected to the internal bus or I/O channels of master system, the driver for the mouse 131 will be loaded when the mouse 131 is connected to the master system through the connector 120. Likewise, the monitor 132 is connected to the internal bus or I/O channels of master system, the driver for the monitor 132 will be loaded when the monitor 132 is connected to the master system through the connector 120.

Please note that the master system 100 can connect to the subsystem 130 in passing-through mode, that is, the devices of the subsystem 130 can be connected to the master system 100 directly without using the connector 120. For example, a mouse of the subsystem 130 can be connected to the master system 100 through an existing USB port of the master system 100 and a monitor of the subsystem 130 can be connected to the master system 100 through an existing HDMI port of the master system 100; and the subsystem 130 can be detected by the master system 100 through detecting the ID of the mouse 131 or the monitor 132 in the subsystem 130.

In addition, an I/O channel of the master system 100 can be connected to an external port through the subsystem 130, for example, an I/O channel of the master system 100 can be connected to a network through the subsystem 130, wherein the subsystem 130 will connect the I/O channel to the network through a network port in the subsystem. Alternatively, a new device can be attached to a port of the subsystem 130 and the new device can be assigned to the subsystem 130 once the ID of the device is known and the loading process for the new device is done. Another example is that the subsystem 130 will pass an I/O channel from the master system 100 to another port in the subsystem 130, for example, the subsystem 130 will receive videos on an I/O channel from the master system 100 and transmit the video to another video port in the subsystem 130.

In another embodiment, as shown in FIG. 1B, an adaptor 140 which connects to a set of I/O channels of master system 100 and can be used to convert signals form the I/O channels into suitable signals for connecting with all the devices in the subsystem 130 to improve flexibility. Adaptor comprise several kinds of interface, for example, one I/O channel has a number of pin for connecting to an input device, such as a mouse; another I/O channel has a number of pins for connecting to a display, such as a monitor; yet another I/O channel has a number of pins for connecting to an audio speaker; Please note that each I/O channel may have any number of pins assigned in the adaptor, it. The I/O channel can be connected to a device directly or indirectly through some conversions, for example, the video signals can be in VGA form or LVDS form, and they can be converted to any other form to connect a monitor. An adaptor is to adapt signals in I/O channels to connect all the external devices in a subsystem. It includes a set of I/O channels, it can be only one channel in certain application, typically, it will include a video channel and an input channel for connecting a mouse; these external devices can be used by the virtual machine independent of the applications running on the master system to enable parallel processing without any I/O conflicts. The first video output channel is using LVDS signals and the first input channel is connecting the external device through USB interface. The virtual machine running in the master system 100 can communicate with the subsystem 130 through a control channel of the adaptor. The subsystem has an ID and the device driver will be installed when the master system detect the ID of the subsystem 130 through the control channel of the adaptor.

Please continue to refer to FIG. 1B. In one embodiment, a power supply 133 is connected to the power management system of master system 100; the power supply 133 can be used to support all the devices in the subsystem 130 as well. A control device 134 is connected to the internal bus or I/O channels of master system 100, the driver for control device 134 will be loaded when the control device 134 is connected to the master system 100 through the connector 120. The control device 134 can collect all the information of the devices in the subsystem 130 and store them in a storage device such as a flash memory; alternatively, if all the devices in the subsystem 130 are fixed without any changes, then all the information of the devices in the subsystem 130 can be fixed in the very beginning and stored into a memory such as a flash device for the master system 100 to read; and the master system 100 can control the sequence of loading each device driver for each devices of the subsystem 130 so that the master system 100 can load the driver one by one to improve reliability and efficiency of loading device drivers when the subsystem 130 is connected to the master system 100. In summary, before the VM 110 can use the subsystem 130, the device driver will be loaded for connecting each external device through the adaptor, turn on the VM 110, and then dispatch the device driver to VM 110. Alternatively, the device driver can be loaded and dispatched to VM 110 before turning on the VM 110. In addition, after the VM 110 is running, a new device can be added into the subsystem and the device driver of the new device can be dynamically loaded by sending a command from the master system to VM 110 to load a specified driver for VM 110 itself. The command can be sent from the master system to the VM 110 through many ways such as through network, com ports, or any available internal bridges.

The master system 100, such as a mobile phone or a notebook, has an operating system and its own input devices and output devices, such as a mouse and a monitor for running applications. In order to allow the master system 100 to detect and identify the subsystem 130, there are many different ways to achieve that, for example, there is a dedicated pin, which can be called ID pin in the connector 120, which will be pulled Low when the subsystem 130 is plugged, otherwise, the ID pin will be pulled High all the time through the master system 100. Once the ID pin is detected Low, the master system 100 can turn on the second video channel for running the VM 110.

The master system 100 normally run its application on a main display and a main keypad or keyboard, however, if we want to run parallel applications using virtual machine (VM 110), it is more convenient to use a separate monitor and a keyboard or a mouse for running the virtual machine independently without using the main display or the main touchpad or keyboard to enable truly parallel processing. The adaptor is a connector to group a set of I/O channels to connect a subsystem which can include monitor, mouse or a keyboard for running the virtual machine. We can also implement a security mechanism for check the authorization of a user before connecting the subsystem to the master system to run the virtual machine as well. The security mechanism can be installed in the control device, for example, the control device will handshake with the master system to ensure a security key is correct for getting the authorization to access the devices of subsystem 130.

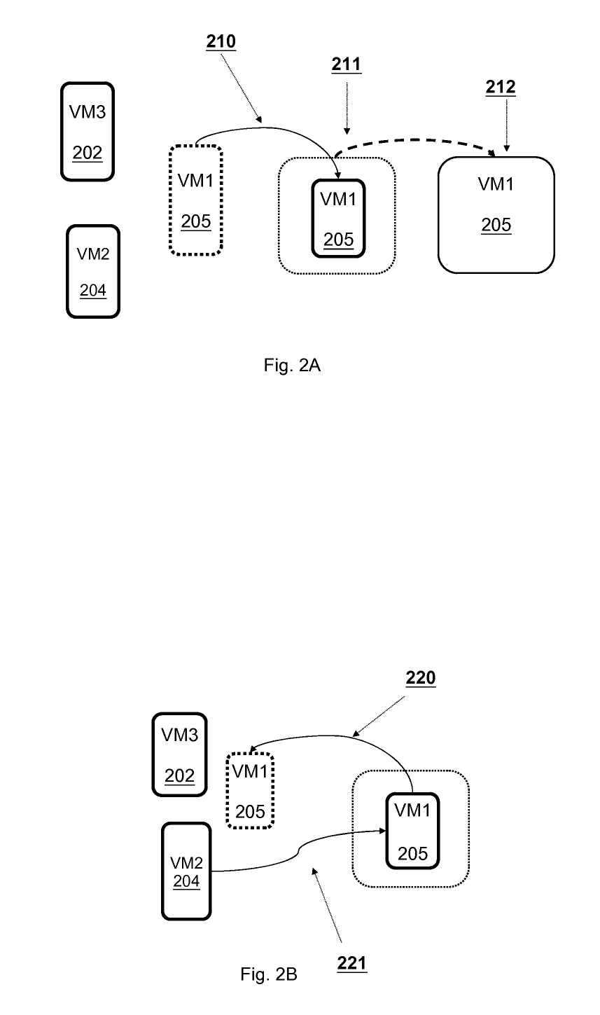

When the master system 100 has loaded all the device of the subsystem 130 or the subsystem 130 is detected, it will update the status on a GUI (graphic user interface) and prompt users to run a VM 110 or select a VM 110 to run. As shown in FIG. 2A, there is a window for a user to select a particular VM by moving the token of a VM into the window. For example, the VM1 205, VM2 204 and VM3 202 are available for running as a virtual machine on the master system. The virtual machines VM1 205 can be activated dragging it into the window with dotted lines 211 to indicate it is starting the VM loading process, and then the dotted lines will be turned into solid lines 212 when the VM is ready.

As shown in FIG. 2B, VM1 205 can be removed from the VM window and VM2 204 can be moved into the VM window to replace the VM1 205.

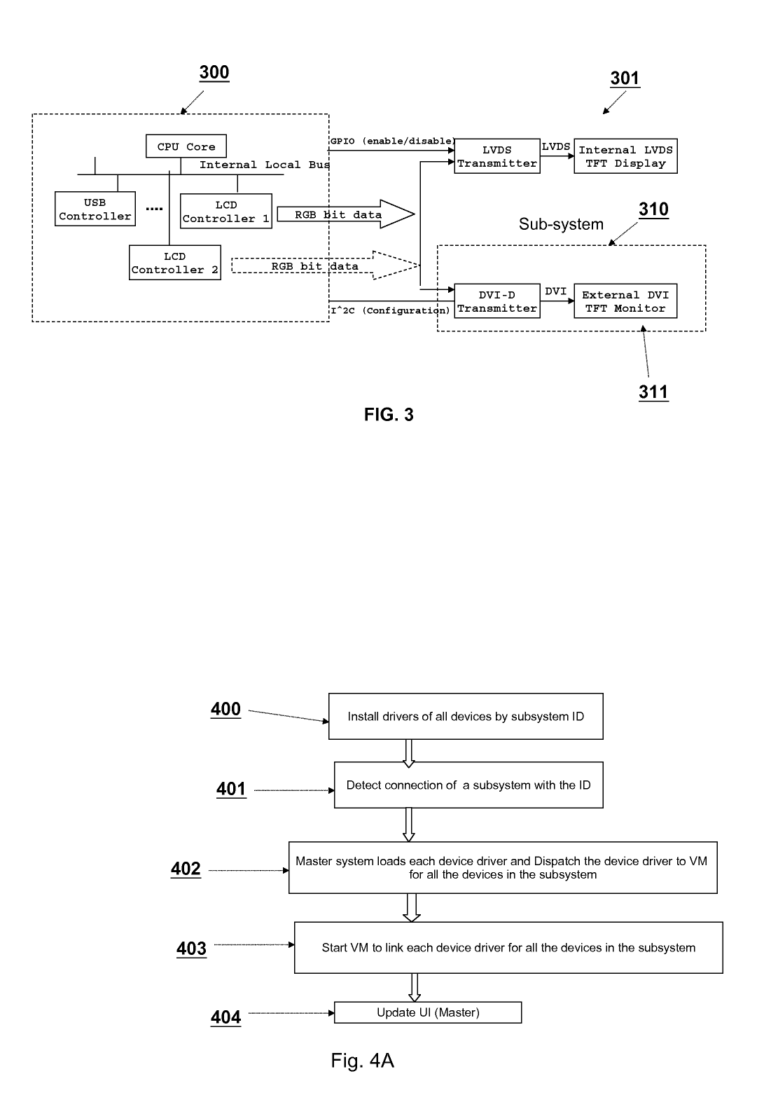

As shown in FIG. 3, master system 300 can provide multiple LCD controllers or graphic chip to deliver two video channels with different power requirements and resolutions. The graphic chip provides the first video output channel and the second video output channel. The master system 300 uses the first video output channel to connect to the Internal LVDS TFT Display 301 for running its own applications for the master system. The subsystem 310 uses the second video output channel to connect to an External DVITFT Monitor 311 for running applications on VM. The first video output channel and the second video output channel can be swapped by an external button for flexibility. Furthermore, the first video output channel can be cut off on the master system when the second video output channel is running for the VM.

Powering up the virtualization system can be done in many different ways.

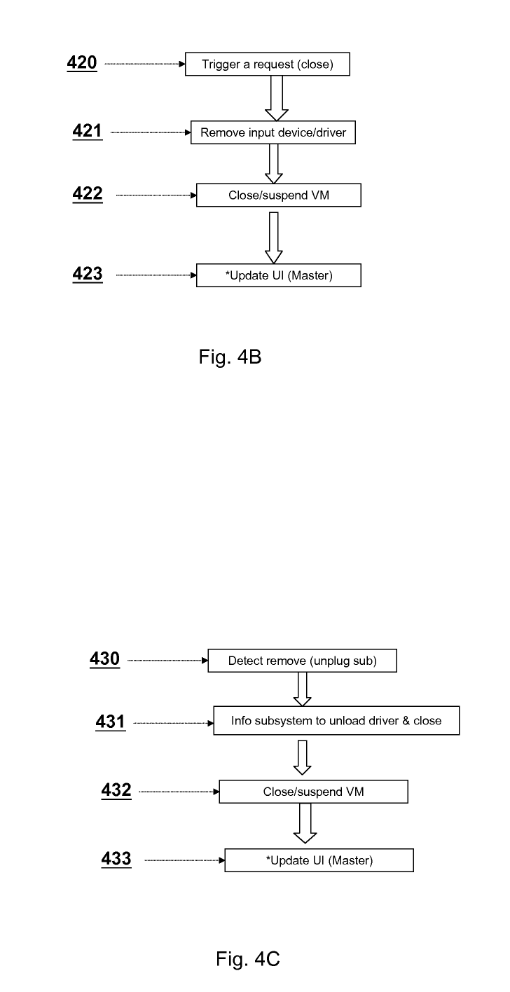

FIG. 4A shows a flow chart to start up a sub-system. In one embodiment as shown in FIG. 4A, the driver is set up by the master for a subsystem with an ID 400 first, then a subsystem with the ID is detected 401, which will trigger the master system to load the device drivers for the subsystem according to the ID of the subsystem and dispatch the device drivers to the VM 402. Then, the VM is started and all the device drivers for the subsystem are linked to the VM 403 for running applications. Optionally, the UI (user interface) can be updated 404 to indicate that the VM is ready for running applications.

Please note that the order of the step in FIG. 4A is not fixed as long as all the requirement for running the VM is met, for example, the VM can be started after the subsystem is detected or after the device drivers are loaded.

FIGS. 4B and 4C shows different ways to terminate or suspend the sub-system. The VM can be closed by removing or de-installing the device driver from the master system by a request or by detecting the connections between the master system and the subsystem automatically. Please refer to FIG. 4B. A request 420 is trigged first, and then all the device drivers will be removed or de-installed 421. Then the VM is closed or suspended 422, and the GUI is updated 423. Please refer to FIG. 4C. The subsystem is removed first 430, and then the master will be aware to de-install all the drivers 431 of the subsystem. Then the VM is closed or suspended 422, and the GUI is updated 423.

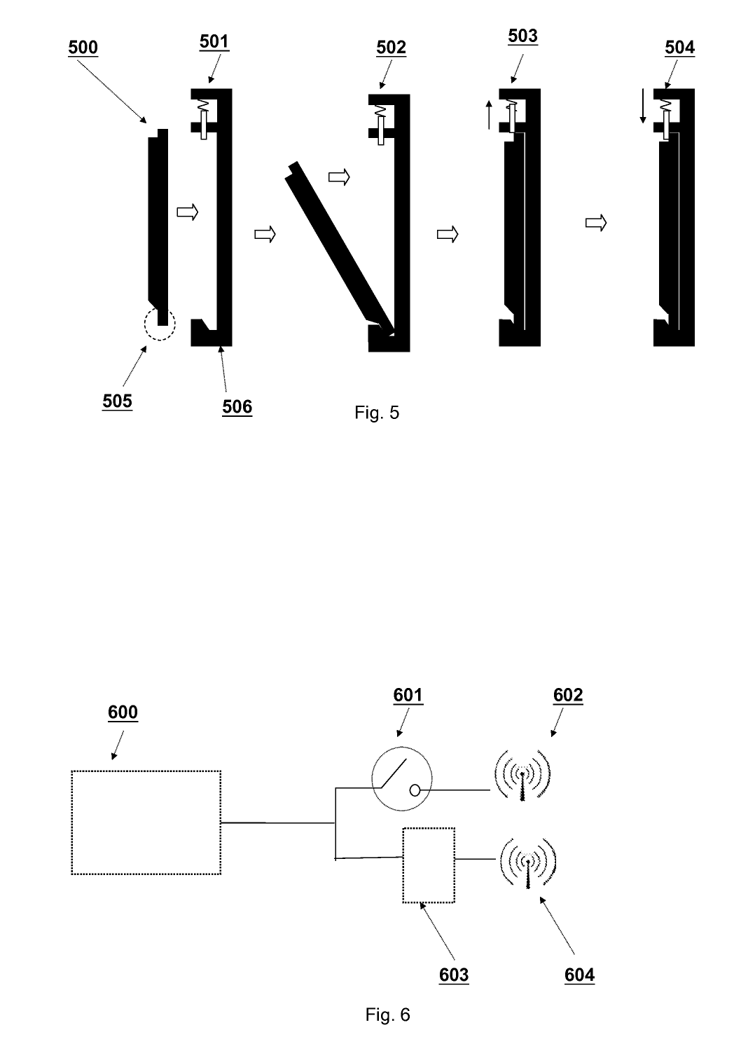

FIG. 5 shows a subsystem 501 has a mechanical base to sit the master system 500 which can be a mobile phone with a connector 505 which includes pins of a set of I/O channels for connecting with a subsystem 501, and the base of the subsystem 501 has a corresponding connector 506 to connect the connector 505. For example, the mobile phone can be placed into the base so as to connect to the subsystem as illustrated in steps 502, 503 and 504. Please note that the base can have a big surface to dissipate the heat generated by the master system such as a mobile phone.

FIG. 6 shows a subsystem has an adaptor 603 which has an external wireless antenna 604 to replace an internal antenna 602 through a relay 601. The internal antenna 602 can be switched to the external antenna 604 for connecting with a wired device 600. For example, the relay which can be switched off when the adaptor is plugged-in so that the external antenna 604 will be used for running the applications on the virtual machine and/or the master system to improve the quality or speed. The external antenna 604 can replace the internal antenna 602 in many ways, not limited to the relay 601; another way to do it is by using mechanical design to achieve that.

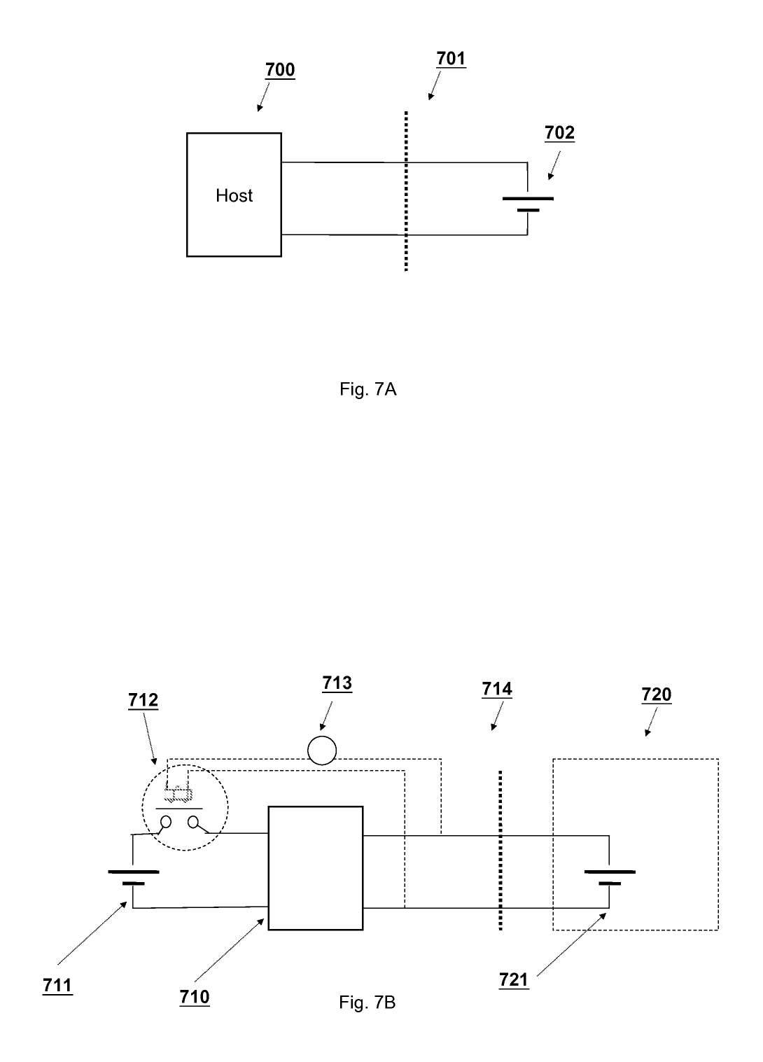

FIGS. 7A and 7B show different ways to connect an external power supply to the external adaptor. FIG. 7A shows an adaptor 701 connecting with an external power supply 702 which be used for powering the adaptor. FIG. 7B shows that a subsystem 720 has an adaptor 714 and an external power supply 720 which can replace the original power supply 711 of the master system 710 through a relay 712 with a delay 713 to ensure power is not interrupted during power supply swapping. The external power supply 702 can replace the original power supply in many ways, not limited to the relay; another way to do it is by using mechanical design to achieve that.

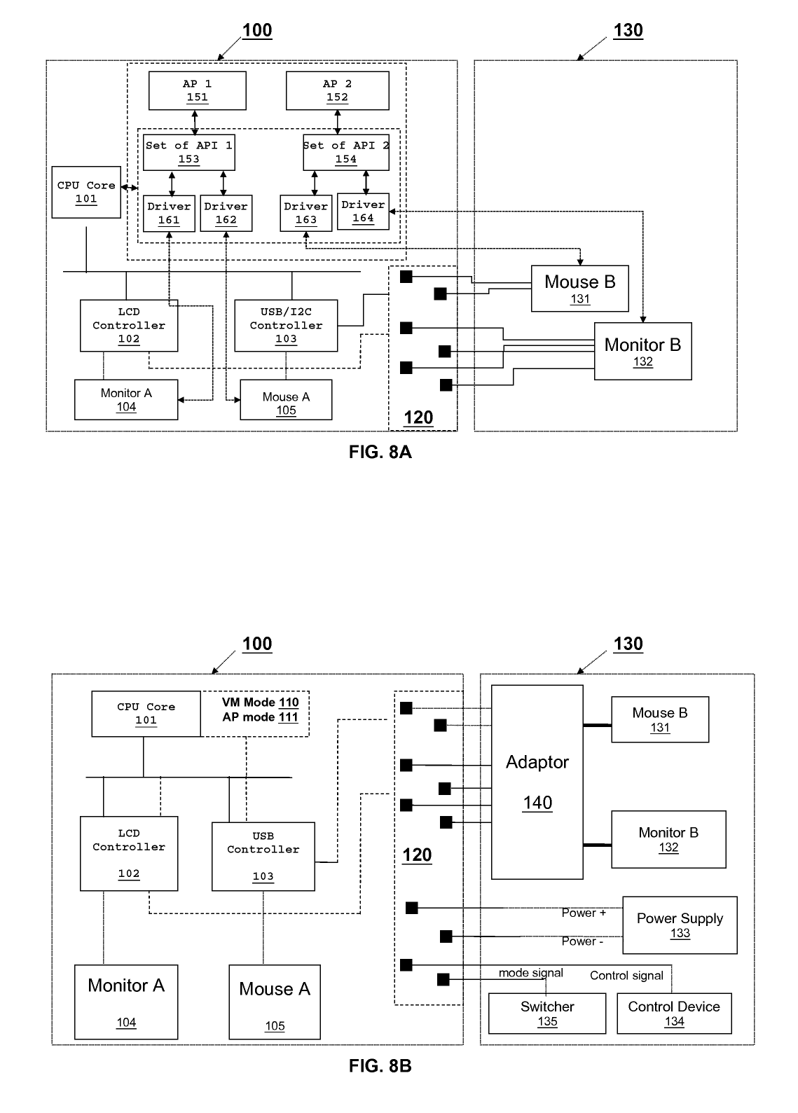

FIG. 8A shows a schematic diagram in accordance with another embodiment. There is one application AP1 151 running in the master system 100 using a monitor 104 and a mouse 105; and another application AP2 152 running on an external monitor 132, which means the application AP2 152 has its own display or monitor 132 independent of the display or monitor 104 used by the application AP1 151 in the master system 100. The AP2 151 can access the monitor 104 and the mouse 105 through one set of Application Programming Interface API_{—}1 153 which links to a monitor driver 161 and a mouse driver 162 and to access the mouse the monitor 104 and the mouse 105. The AP2 152 can access the subsystem through another set of Application Programming Interface API_{—}2 154 which links to a mouse driver 163 and a monitor driver 164 to access the mouse 131 and the monitor 132.

The master system 100 is connected to an external subsystem 130 which includes some I/O devices, such as a mouse 131, a keyboard, a monitor 132, a touch-panel, audio speaker, etc., which provides a great deal of flexibility and adaptability to any environment, such as connecting the subsystem into a desktop, a notebook, a mobile phone or any computing devices capable of running an application. By doing this way, the I/O devices used by the applications running on the master system 100 can be independent of the I/O devices used by the application AP2 152; and the I/O devices in the subsystem 130 can be added and configured through loading a device driver corresponding to the subsystem 130 after the master system 100 is power-up and running.

Please continue to refer to FIG. 8A. In one embodiment, the master system 100 has a connector 120 for connecting with the subsystem 130. The mouse 131 is connected to the internal bus or I/O channels of master system, the driver for the mouse 131 will be loaded when the mouse 131 is connected to the master system 100 through the connector 120. Likewise, the monitor 132 is connected to the internal bus or I/O channels of master system 100, the driver for the monitor 132 will be loaded when the monitor 132 is connected to the master system through the connector 120.

Please note that the master system 100 can connect to the subsystem 130 in passing-through mode, that is, the devices of the subsystem 130 can be connected to the master system 100 directly without using the connector 120. For example, a mouse of the subsystem can be connected to the master system 100 through an existing USB port of the master system 100 and a monitor of the subsystem 130 can be connected to the master system 100 through an existing HDMI port of the master system 100; and the subsystem 130 can be detected by the master system 100 through detecting the ID of the mouse or the monitor in the subsystem 130.

In addition, an I/O channel of the master system 100 can be connected to an external port through the subsystem 130, for example, an I/O channel of the master system 100 can be connected to a network through the subsystem 130, wherein the subsystem 130 will connect the I/O channel to the network through a network port in the subsystem 130. Alternatively, a new device can be attached to a port of the subsystem 130 and the new device can be assigned to the subsystem 130 once the ID of the device is known and the loading process for the new device is done. Another example is that the subsystem 130 will pass an I/O channel from the master system 100 to another port in the subsystem 130, for example, the subsystem 130 will receive videos on an I/O channel from the master system 100 and transmit the video to another video port in the subsystem 130.

In another embodiment, as shown in FIG. 8B, an adaptor 140 which connects to a set of I/O channels of master system 100 and can be used to convert signals form the I/O channels into suitable signals for connecting with all the devices in the subsystem 130 to improve flexibility. Adaptor comprise several kinds of interface, for example, one I/O channel has a number of pin for connecting to an input device, such as a mouse; another I/O channel has a number of pins for connecting to a display, such as a monitor; yet another I/O channel has a number of pins for connecting to an audio speaker; Please note that each I/O channel may have any number of pins assigned in the adaptor, it. The I/O channel can be connected to a device directly or indirectly through some conversions, for example, the video signals can be in VGA form or LVDS form, and they can be converted to any other form to connect a monitor. An adaptor is to adapt signals in I/O channels to connect all the external devices in a subsystem. It includes a set of I/O channels, it can be only one channel in certain application, typically, it will include a video channel and an input channel for connecting a mouse; these external devices can be used by the application independent of the applications running on the master system to enable parallel processing without any I/O conflicts. The first video output channel is using LVDS signals and the first input channel is using USB signals in the connecting bus for connecting the external device. The application running in the master system 100 can communicate with the subsystem 130 through a control channel of the adaptor. The subsystem 130 has an ID and the device driver will be installed when the master system 100 detect the ID of the subsystem through the control channel of the adaptor.

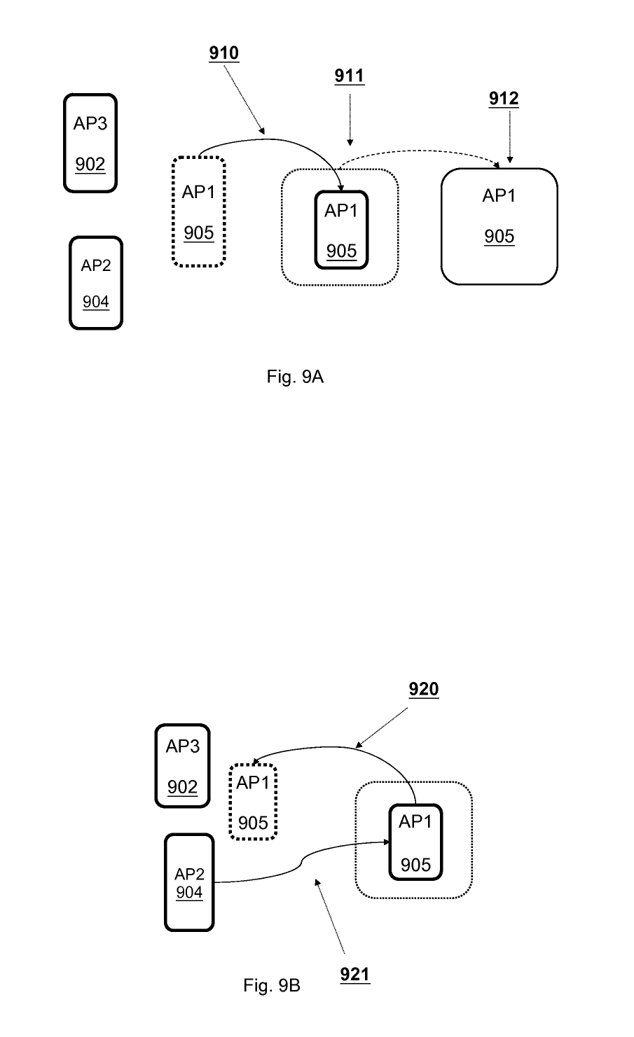

Please continue to refer to FIG. 8B. We have described an application can run on a subsystem either directly or through a virtual machine. As shown in FIG. 8B, there are two modes for running applications on the subsystem, one is VM mode 110 and the other is AP mode 111. Three is a switcher 135 in the subsystem, which can be used to select either the VM mode 110 or the AP mode 111. There are many other mechanisms can do the selection between the VM mode or AP mode, for example, through a first window for selecting the VM mode or a second window to select the AP mode as shown in FIG. 2A and FIG. 9A.

When the master system 100 has loaded all the device of the subsystem or the subsystem is detected, it will update the status on a GUI (graphic user interface) and prompt users to run an application or select an application to run. As shown in FIG. 9A, there is a window for a user to select a particular application by moving the token of an application into the window. For example, the AP1 905, AP2 904 and AP3 902 are available for running as an application on the master system 100. The applications AP1 205 can be selected to run on the subsystem 130 by dragging it into the window with dotted lines 911 to indicate it is starting the selecting process, and then the dotted lines will be turned into solid lines 912 when the AP1 205 is ready to run on the subsystem 130.

As shown in FIG. 9B, AP1 205 can be removed from the window and AP2 204 can be moved into the window to replace the AP 205 so that the AP 205 will run on the subsystem 130 instead.

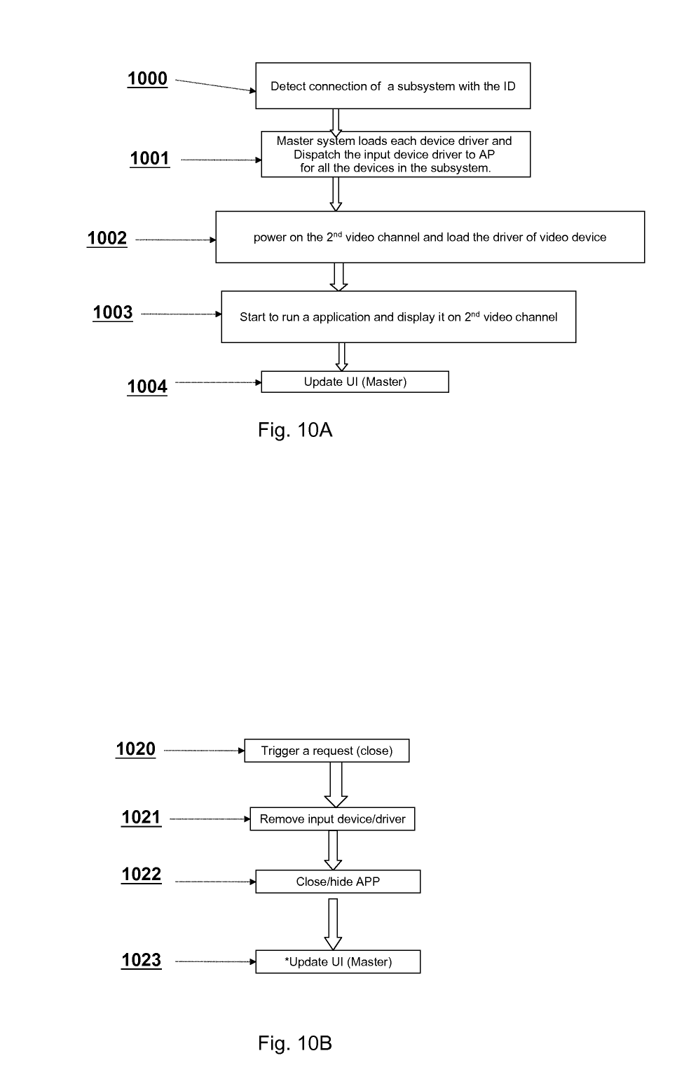

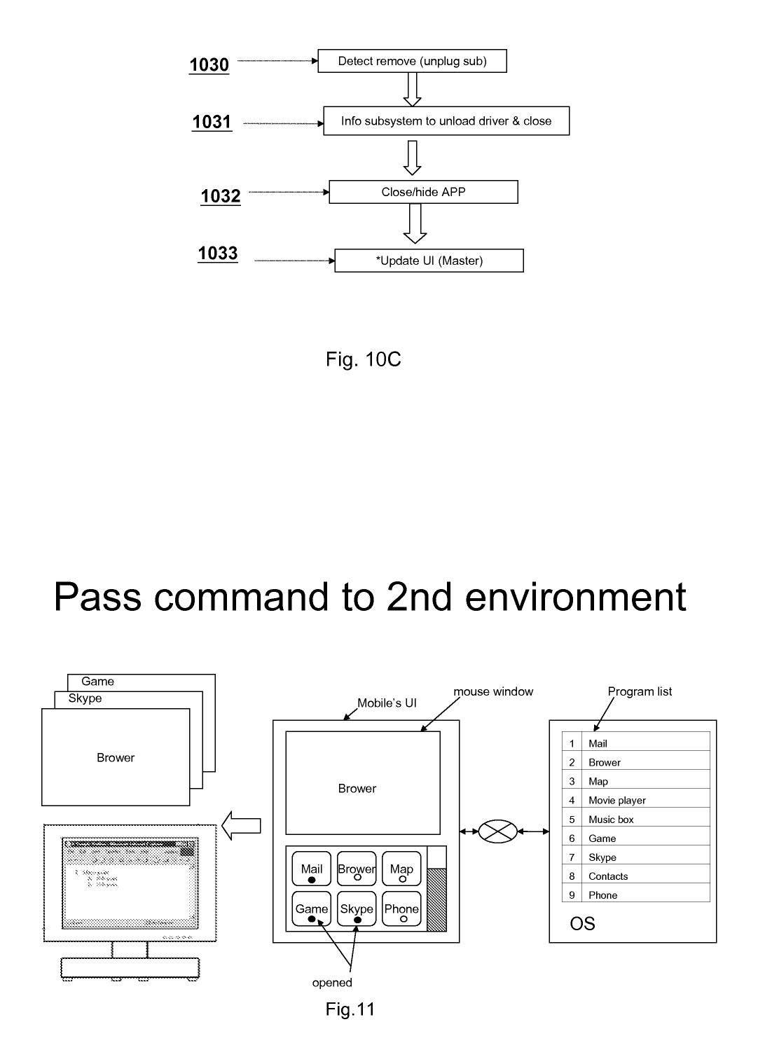

FIG. 10A shows a flow chart to start an application to run on a sub-system 130. In one embodiment as shown in FIG. 4A, the driver is set up by the master for a subsystem 130 with an ID 1000 first, then a subsystem 130 with the ID is detected 1001, which will trigger the master system 100 to load the device drivers for the subsystem 130 according to the ID of the subsystem 130 and dispatch the device drivers to an AP (application) 1002. Then, the AP is started and all the device drivers for the subsystem 130 are linked to the AP 1003 for running the AP on the subsystem. Optionally, the UI (user interface) can be updated 1004 to indicate that the AP is ready for running.

Please note that the order of the step in FIG. 10A is not fixed as long as all the requirement for running the AP is met, for example, the AP can be started after the subsystem is detected or after the device drivers are loaded.

FIGS. 10B and 10C shows different ways to terminate or suspend the sub-system. The AP can be closed by removing or de-installing the device driver from the master system by a request or by detecting the connections between the master system and the subsystem automatically. Please refer to FIG. 10B. A request 1020 is trigged first, and then all the device drivers will be removed or de-installed in step 1021. Then the AP is closed or suspended in step 1022, and the GUI is updated in step 1023. Please refer to FIG. 10C. The subsystem is removed first in step 1030, and then the subsystem will be informed to de-install all the drivers in step 1031. Then the AP is closed or suspended in step 1022, and the GUI is updated in step 1023.

FIG. 11 shows that a command can be sent from a mobile GUI to the second environment running on the subsystem. A program list or tokens can be displayed on the mobile GUI for a user to select which program can be moved to the second environment for running.

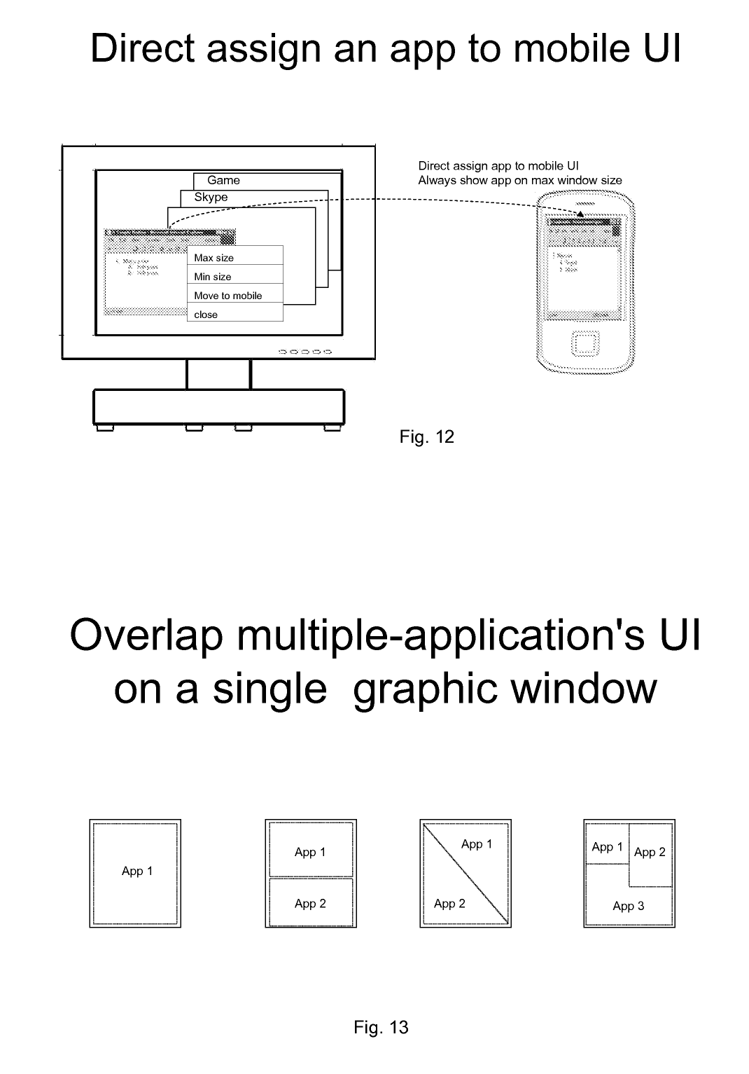

FIG. 12 shows that a command can be sent from a desktop GUI running on the subsystem to the mobile phone. A program list or tokens can be displayed on the desktop GUI for a user to select which program can be moved to the mobile phone for running. Please note that when selected program is is moved to a new environment, it can be initiated to run automatically.

FIG. 13 shows that multiple applications can be shown on a single screen.

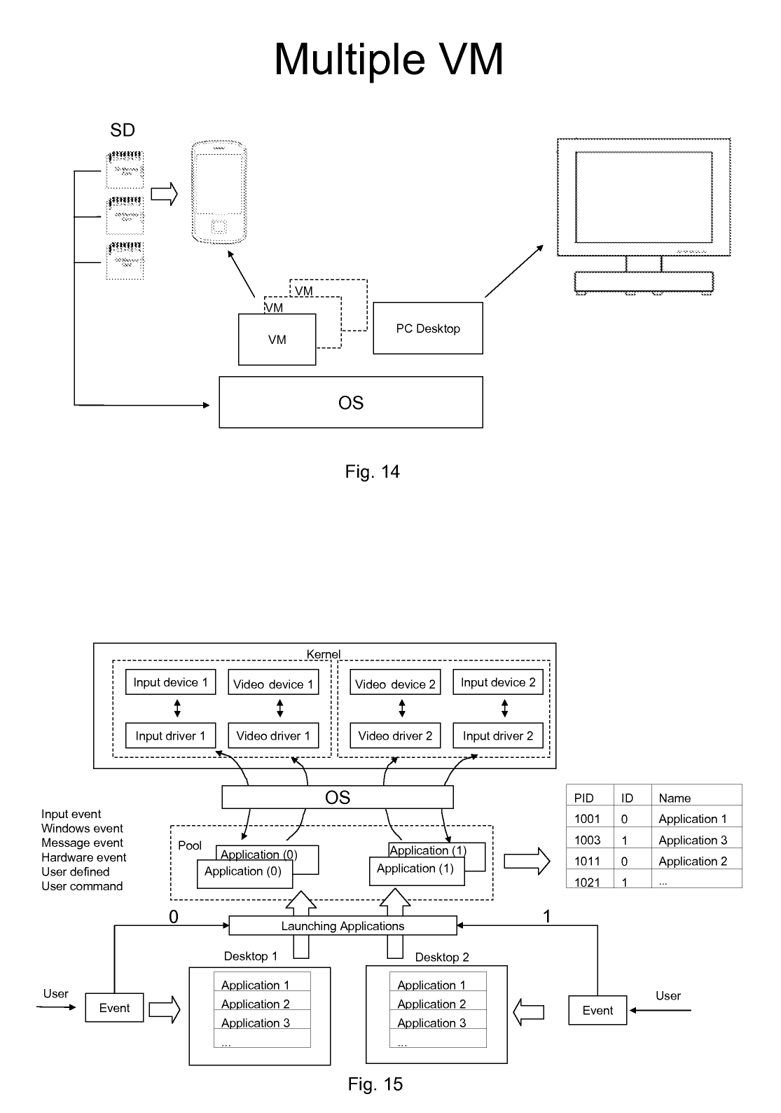

In one embodiment, FIG. 14 shows that a mobile computing device, comprising an operating system; a first set of I/O channels having a first video channel connected to a first display unit and a first input channel connected to a first input unit; a second set of I/O channels having a second video channel and a second input channel; and at least one connector for connecting an external subsystem to the second set of I/O channels, wherein the external subsystem comprises a second display unit and a second input unit, wherein when the subsystem is not connected to the mobile phone, at least one application runs on the operating system and the first set of I/O channels; and when the subsystem is connected to the mobile phone, a first application runs on the operating system and the second set of I/O channels and a second application runs on a first virtual machine (VM) on top of the operating system and the first set of I/O channel. The VM can be light VM that only handles 3G/4G/wireless applications. The light VM can be a single task VM that can run one application all the time, another application can not be run until the current running application is terminated. Multiple single task VM can be run concurrently to support more applications on the mobile phone environment.

In one embodiment, the virtual machine (VM) is pre-integrated with the operating system. In one embodiment, the virtual machine (VM) is dynamically loaded and link with the operating system when the external subsystem is connected to the mobile phone. In one embodiment, the hardware resource is displayed on the mobile phone or big screen so as to change the ownership to either the native operating system (OS) or the virtual machine (VM). In one embodiment, VM only allow one application to run at a time, when one application or task is completed, then another application or task can be executed, in this way, a desktop manger that can handle multiple concurrent applications or tasks is not necessary.

In one embodiment, a method to operate a mobile computing device, comprising: running a first application on a operating system and a first set of channels of the mobile phone, wherein the first application runs on the operating system natively; connecting an external subsystem to the mobile phone through at least one connector of the mobile phone; altering the desktop operating system to run on the second set of channels of the mobile phone; and running a second application on a virtual machine (VM) on top of the operating system and the first set of channels.

In one embodiment, the virtual machine (VM) is started when the subsystem is connected to the mobile phone and is suspended or closed when the subsystem is not connected to the mobile phone.

In one embodiment, the method further comprises calling a first call-back function to move the first application from the first display unit to the second display unit, wherein the first application changes from a first resolution configured for the first display unit to a second resolution configured for the second display unit without any interruption while the first application is running, wherein the first resolution is lower than the second resolution.

In one embodiment, the method further comprises passing the control of at least one application, which is currently running on the first display unit, from the operating system to the virtual machine (VM).

In one embodiment, FIG. 15 illustrates a multi-computing environment, comprising: an operating system; a plurality of video channels for displaying; a plurality of input channels for inputting commands; a plurality of applications running on top of operating system without any virtualization; wherein each application is assigned a PID and the PID is associated with a video channel when the application is launched by a command inputted from an input channel, wherein the application is running on the video channel and the input channel in the multi-computing environment. Each individual video channel can be used for displaying message or images on a display unit. The video channel can be in many forms, such as VGA, RGB, HDMI, or any suitable bus to deliver the video and images. In one embodiment, the video channel can be linked to a remote terminal, wherein the video channel sends the messages and images to the remote terminal in packets. From operating system point of view, there is a plurality of independent video channels in a multi-computing environment. When an application runs on a video channel and an input channel, the application can receive commands from the input channel and display messages or images through the video channel. That is the input channel is associated with the video channel, acting as a console for the application. When an input channel is received a command to launch an application, the application is assigned a PID and the PID will be associated with the video channel that is associated with the input channel. Therefore, if they are multiple input channels and video channels, multiple applications can be run on a single operating system concurrently, wherein each application is bound to an input channel and a video channel, respectively. For example, a first application is bound to a mouse and a monitor; and a second application is bound to a touch panel which includes a monitor and an input channel.

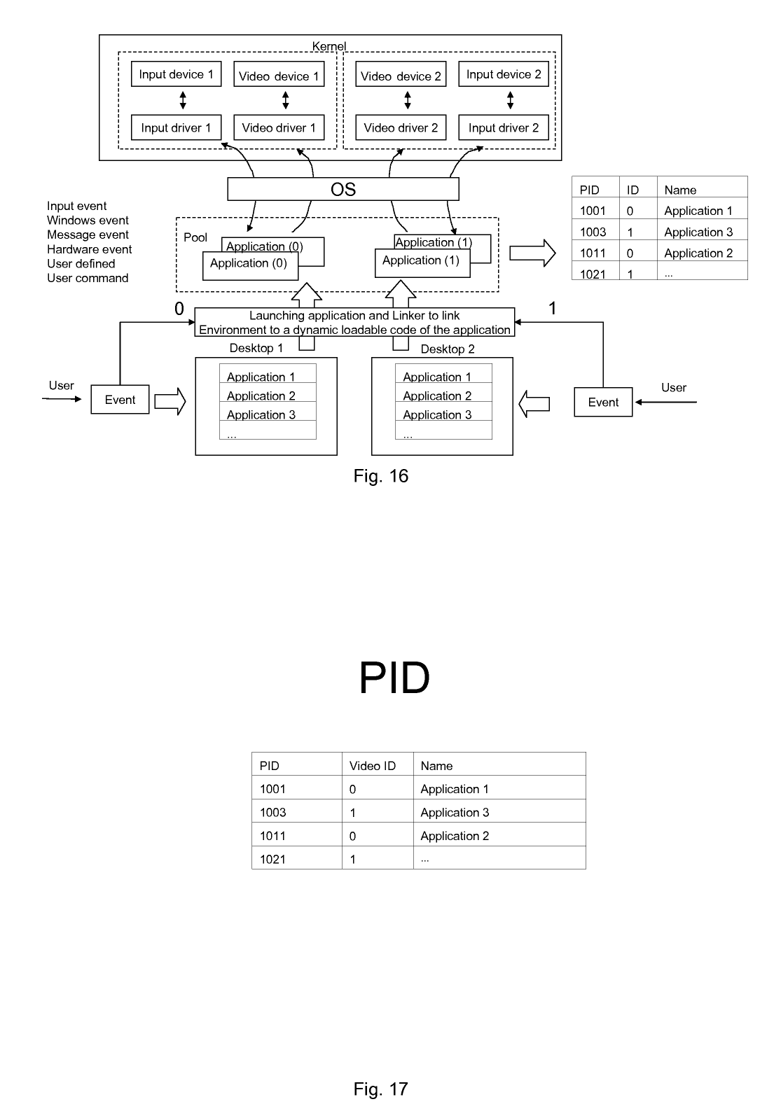

FIG. 16 shows a map to map a PID to a video channel so that any application asking video services can be distinguished by checking the map. For example, if an application is sending a video service packet to the operating system, for example, the kernel of the operating system will check the PID map to obtain the video channel corresponding to the current PID to which the application is assigned, so as to access the correct video channel hardware access correctly. The PID map can be stored in memory or a cache memory, or a Content addressable Memory (CAM) device for highest performance.

In multi-processors environment, the PID will be uniquely assigned among applications running on all the processors so that the PID map table can be implemented in a single map or table.

A management interface can be provided to assign video channels to all the applications or re-assign video channels when the applications are actually running. The video channels can be dynamically assigned to a set of applications. For example, if they are 100 users running 100 applications but with only 10 video channels, the management can also specify the priority group among the 100 applications, or the management can change the assignment directly. The binding of the video channels to the 100 applications can be forced through the management as well. Once an application is pre-assigned a video channel, the PID of the application will be bound to the application when the application is launched.

FIG. 17 shows a video channel ID can be stored in the context of each application, so that any application asking video services can be distinguished by checking the context associated with the current PID. For example, if an application is sending a video service packet to the operating system, for example, the kernel of the operating system will check the context of the PID of the current process to obtain the video channel corresponding to the current PID to which the application is assigned, so as to access the correct video channel hardware access correctly. In FIG. 18, Context(0) means the process is associated with video channel 0; and Context(1) means the process is associated with video channel 1, respectively.

In one embodiment, a mobile computing device, comprising: an operating system; a first set of I/O channels having a first video channel connected to a first display unit and a first input channel connected to a first input unit; a second set of I/O channels having a second video channel and a second input channel; and at least one connector for connecting an external subsystem to the second set of I/O channels, wherein the external subsystem comprises a second display unit and a second input unit, wherein when the subsystem is not connected to the mobile phone, at least one application runs on the operating system and the first set of I/O channels; and when the subsystem is connected to the mobile phone, a first application runs on the operating system and the first set of I/O channels and a second application runs the operating system and the second set of I/O channel, wherein the first application runs on top of the operating system natively without any virtualization between the first application and the operating system; and the second application runs on top of the operating system natively without any virtualization between the second application and the operating system, wherein the first application is associated with the first set of I/O channels for accessing the first display unit and the first input unit; and the second application is associated with the second set of I/O channels for accessing the second display unit and the second input unit through the operating system, respectively and concurrently.

When a first application is launched from the first input unit, a command or event will be generated by the first input unit and sent to a desktop manger or another control manager. For example, if the icon of first application is clinked by a first mouse, the location information will be sent to a desktop manager or a control manager, and a first process ID will be assigned to the first application accordingly. Since the first application is triggered from the first input unit, the first process ID of the first application will be bind to the first display unit. Likewise, when a second application is launched from the second input unit, a command or event will be generated by the first input unit and sent to a desktop manger or another control manager. For example, if the icon of second application is clinked by a second mouse, the location information will be sent to a desktop manager or a control manager, and a second process ID will be assigned to the second application accordingly. Since the second application is triggered from the second input unit, the second process ID of the second application will be bind to the second display unit. By doing so, each application will be assigned a process ID and the process ID will be bind to a video channel when the application is launched. When an application is running and calls a video service, the call will be handled by the operating system either through software interrupt, trap, inter-process communication or other suitable ways. When the operating system receives the video service request, it will first obtain the current process ID that is running, and the current process ID is the process ID of the application that called the video service, because only one processed is allowed to be running for a given time. The operating system communicates with a corresponding video device driver of the video channel that is bound to the process ID of the calling application so that the video service can be performed by the video device driver. Threads will be handled like the process. A thread is generated by a parent process, when thread is launched, a thread ID is assigned and the thread ID can be bound to the same video channel which is assigned to its parent process. Please note that the first application can be launched or initiated from many different ways. For example, FIG. 11 shows that a command can be sent from a mobile GUI to the second environment running on the subsystem. A program list or tokens can be displayed on the mobile GUI for a user to select which program can be moved to the second environment for running, after the selected program is moved to the second environment, the selected program can be launched automatically by sending a command to the desktop or control manager of the second environment to launch the selected program through the desktop or control manager of the second environment.

Middleware, for example, can be shared among applications running in middleware, the process ID of the process will be known by the middleware, and the middleware can get the video channel number of the process according to the process ID. For example, if the middleware is running in user space, the middleware can ask the operating system to provide the video channel number of the process ID so that video service call can be performed by the middle ware on behalf of the application.

In one embodiment, FIG. 18 illustrates a multi-computing environment, wherein the first video channel is associated with the first application by dynamically linking a first service entry point of the first video channel to a first symbol of the first application, wherein the first symbol is in a first object code of the first application for linking with a video service; and when the second application is launched from the second display unit, the second video channel is associated with the second application by dynamically linking a second service entry point of the second video channel to a second symbol of the second application, wherein the second symbol is in a second object code of the second application for linking with a video service. In certain operating system, the device driver can be dynamically linked to the application through the linker and after the linker defines all the real address for the application, the application can be bound to the device driver.

In the operating system, the internal generated process, applications, threads can be aware of the multi-environments and have them bound to a corresponding video channel. For example, a first desktop manager of the first display unit will be bound to the first video channel; and a second desktop manager of the second display unit will be bound to the second video channel, respectively. For disk files, each file manager will be bound to a video channel, wherein the file manager is launched from the input channel associated with the corresponding video channel.

In one embodiment, when a first application is launched from the first display unit, the first video channel is associated with the first application by dynamically linking a first service entry point of the first video channel to a first symbol of the first application, wherein the first symbol is in a first object code of the first application for linking with a video service; and when the second application is launched from the second display unit, the second video channel is associated with the second application by dynamically linking a second service entry point of the second video channel to a second symbol of the second application, wherein the second symbol is in a second object code of the second application for linking with a video service. The operating system has a linker to dynamically link the object code with the operating environment and all the symbols in the object code will be defined by the linker and physically convert all the symbols into real numbers that can represent the real addresses of service routines in the operating environment which is running in the mobile phone already. For example, if the operating system supports a first video service routine of the first video channel having a first starting address as the service entry point, and a second video service routine of the second channel having a second starting address as the service entry point, when the first application is launched, the first starting address will be bind to the symbol, for linking with a service entry point, in the object code of the first application dynamically; likewise, when the second application is launched, the second starting address will be bind to the symbol, for linking with a service entry point, in the object code of the second application dynamically as well. By doing so, the applications can be directed to the correct video channel without any extra provision. Likewise, all other hardware resources can be bind to the applications respectively. For example, if the mobile phone has a first speaker and the subsystem has a second speaker, the binding of speakers to applications can be done in the same way as the video channels.

In one embodiment, the first service entry point of the first video channel is the starting address of a first application program interface (API) for accessing the first video channel; and the second service entry point of the second video channel is the starting address of a second application program interface (API) for accessing the second video channel. The first object code of the first application and the second object code of the second application are generated on top of the native operating system without any virtualization.

In one embodiment, the first application is embedded with a first ID to indicate the first video channel and the second application is embedded with a second ID to indicate the second channel, respectively, for interfacing with at least one service routine for accessing a video channel, respectively.

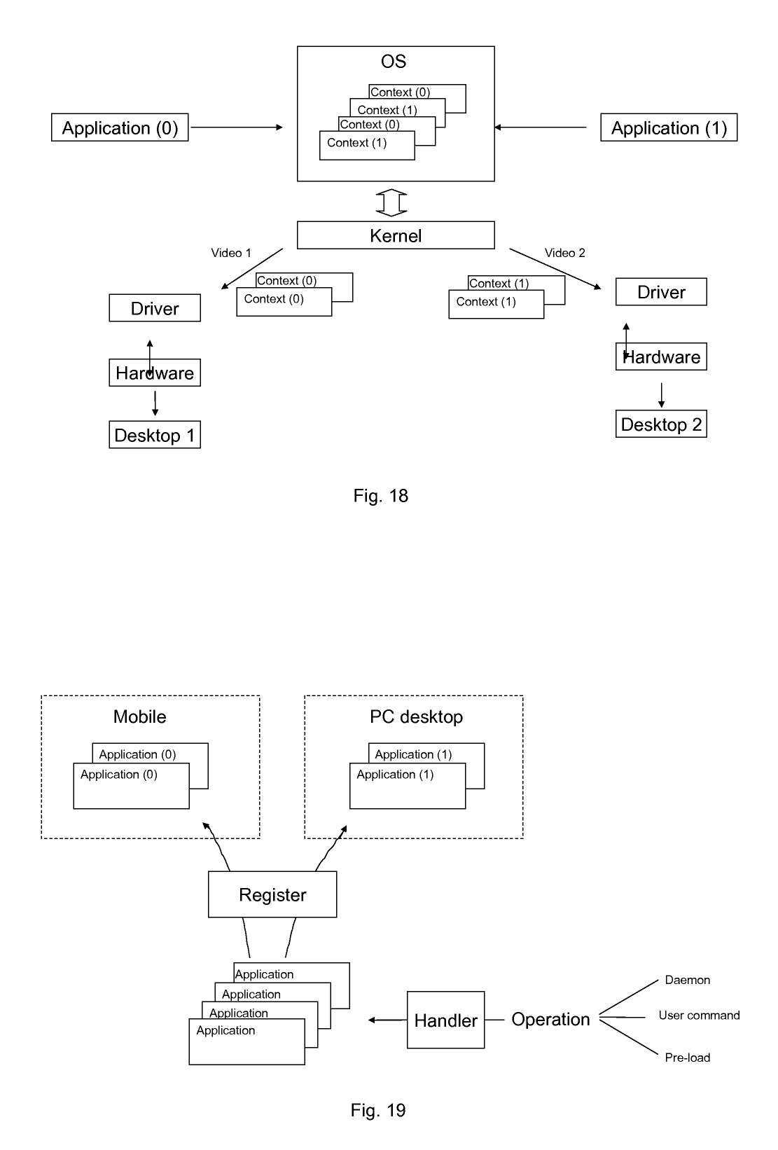

As illustrated in FIG. 19, in one embodiment, the first ID is obtained through a first registration process in which the first application is registered the first ID identifying the first video channel; and the second ID is obtained through a second registration process in which the second application is registered the second ID identifying the second video channel. The tag can be embedded to select one of the video channels, so that the object code of the application already knows which video channel will be used when the application is running. For example, if an application can only run on a big screen, the object code of the application will fix the video channel corresponding to the big screen.

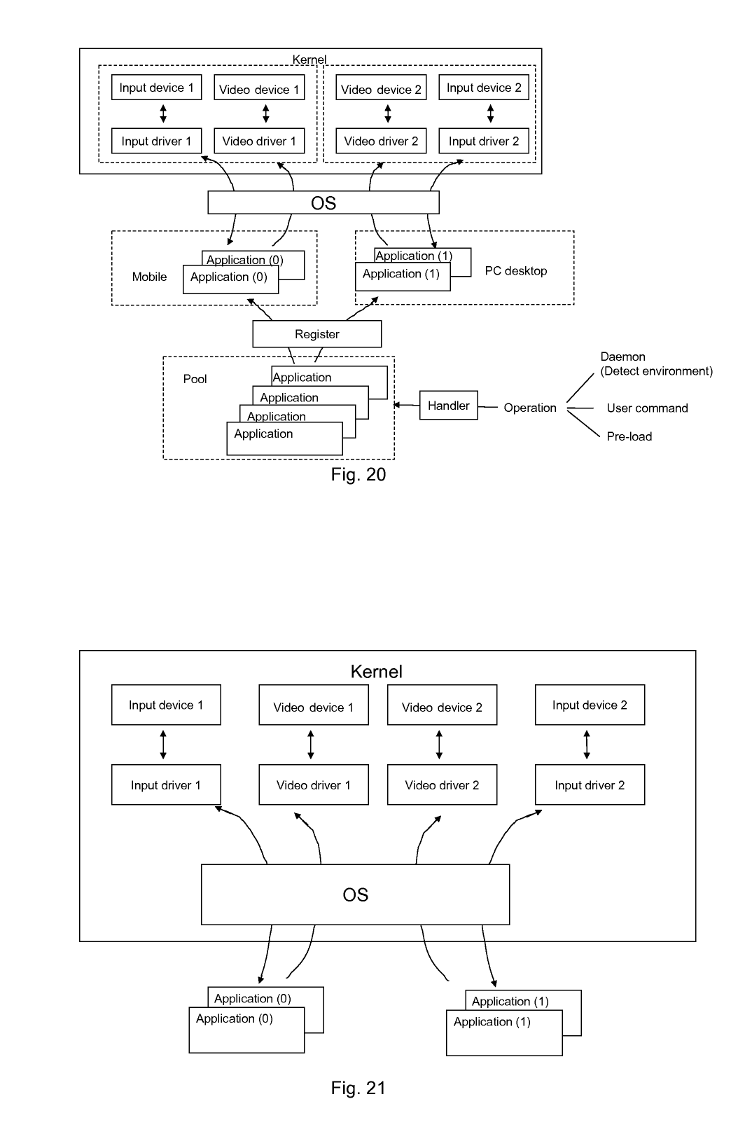

As illustrated in FIG. 20, when an application is launched, it will register a video channel ID from the operating system, and then the application can pass the video channel information down to get a video service accordingly.

In one embodiment, the first application access the first set of I/O channel through at least one first application program interface (API) in accordance with the first ID and the second application access the first set of I/O channel through at least one second application program interface (API) in accordance with the second ID.

As illustrated in FIG. 21, with all the possible ways to allow multiple applications running on a single operating system natively without any virtualization in a multi-computing environment, so that the resources, such as CPU, memory, video, etc., can be fully utilized to reach the highest performance without any overheads of the virtualizations.

In one embodiment, the first application is launched from the first display unit through a first command inputted through the first input unit; and the second application is launched from the second display unit through a second command inputted through the second input unit.

In one embodiment, a first call-back function is provided for the first application so that the call-back function will be called when the subsystem is connected to the mobile phone to move the first application from the first display unit to the second display unit, wherein the first application changes from a first resolution configured for the first display unit to a second resolution configured for the second display unit without any interruption while the first application is running, wherein the first resolution is lower than the second resolution.

In one embodiment, applications which are visible on the first display unit can be directed to be shown and run on the second display unit. Applications which are visible on the second display unit can be directed to be shown and run on the first display unit. In one embodiment, a window is displayed on the first display unit to select one of the applications which are visible on the first display unit to run on the subsystem by moving a token of the selected application into the window. In the above embodiments, the examples in the multi-computing environment and the examples in the mobile computing environment, such as in a mobile phone, can be applied to each other, since the mobile phone is just like a computer as technology advances in a fast pace nowadays.

The video channel binding mechanism described above can be applied to any other hardware resources as well. For example, in addition to a plurality of video channels or video I/O services, a plurality of speakers, printers, fax, backup disk, broadcasting or transmitting devices that allowing the multi-computing environment to transmit signals to outside world, can be bound to applications either dynamically or through a management interface, or through a hardware binding such as all the I/O channels on one adaptor card, or connected through a common connector of the multi-computing environment. PID can be bound to a particular speaker according to the above mentioned rules as well.

In order to be scalable, a single OS can be limited to serve a number of video channels, and another copy of OS can be installed to handle more video channels. Loading balancing between the two operating systems can be achieved by swapping applications along with video channels, or through management interface to bind applications to the operating systems respectively. Memory expansion modules can be provided to increase the capacity of the memory in the system. Multiple service points in the kernel can be provided as well. For example, there are 10 video channels available, the OS has two service points in a kernel. In one case, the 1-5 video channels will be served through the first service point of the kernel while video channels 6-10 will be served through the second service point of the kernel to scale up the performance. The service point in the kernel can be obtained by mapping a PID to a service point of the kernel as well. The mapping a PID to a service point of the kernel as well can be defined by a management interface, or dynamically adjusted through the OS.

File access right control can be implemented by operating system. The operating system will keep a mapping to map a user to a plurality of files or directories, If a user tries to access a forbidden area, the OS will block the access.

The operating system can control the number of the applications that requires licenses so that a remote license server is not necessary. The number of the license applications that can be run at a given time can be controlled by counting the number of the PID(s) which are actually running and the total number of the active PID(s) will be limited by a management interface.

The file or disk access rights can be determined by a user account or through the management interface, and a mapping from a PID to an access right attributes can be implemented as well. The kernel file access service point can obtain the file access right based on the current PID which is assigned to the application making the file access service request. If the access right attributes permits the current file access, the service request will be served, otherwise, the service request will be blocked by the kernel; and a warning message can be deliver to the user or the management interface.

In one embedment, a multi-computing environment, comprising: an operating system having a kernel space; a plurality of hardware resources for providing a service; a plurality of applications running on top of the operating system natively, wherein each of the application is associated with a corresponding hardware resource for obtaining the service; and a common routine outside the kernel space; wherein when each of the application calls the common routine, a corresponding hardware resource of the application is bound to the common routine before executing the common routine for the application.

In one embedment, in the multi-computing environment, the plurality of hardware resources comprises a first video channel and a second video channel for obtaining a video service, and the plurality of applications comprises a first application and a second application, wherein the first application is associated with the first video channel coupling to a first display; and the second application is associated with the second video channel coupling to a second display.

In one embedment, in the multi-computing environment, wherein the plurality of hardware resources comprises a first audio channel and a second audio channel for obtaining an audio service, and the plurality of applications comprises a first application and a second application, wherein the first application is associated with the first audio channel coupling to a first speaker; and the second application is associated with the second audio channel coupling to a second speaker.

In one embedment, in the multi-computing environment, wherein the plurality of hardware resources comprises a first USB channel and a second USB channel, and the plurality of applications comprises a first application and a second application, wherein the first application is associated with the first USB channel; and the second application is associated with the second USB channel.

In one embedment, in the multi-computing environment, wherein each run code of the application is embedded with a tag to indicate its corresponding hardware resource for obtaining the service.

In one embedment, in the multi-computing environment, further comprising a map to associate the hardware resources to the applications respectively, wherein the map is referenced when the application calls the common routine.

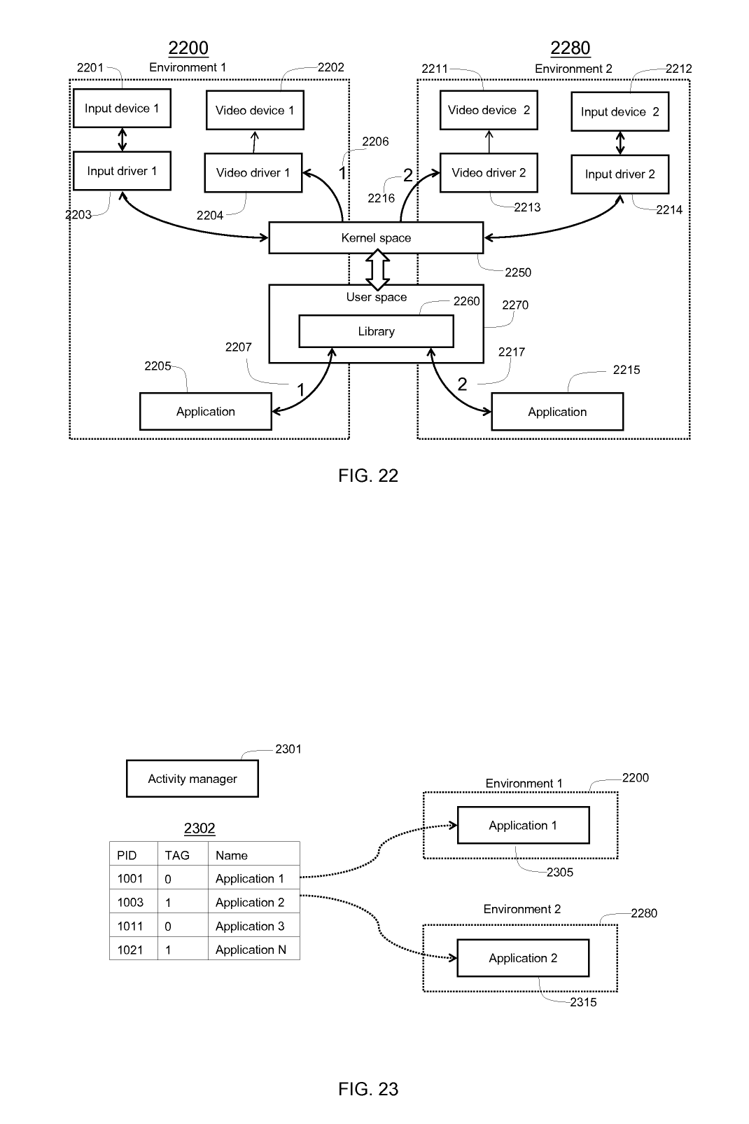

As shown in FIG. 22, the first application 2205 is running in a first environment 2200 and the second application 2215 is running in a second environment 2280. There is a common library 2260 having a plurality of common routines or API(s) that can be called by applications to obtain services through the Kernel Space 2250 so that drivers such as video driver 1 2204 or video driver 2 2213 can be accessed to control video device 1 2202 and video device 2 2211, respectively. The common library is in user space 2270 outside the kernel space 2250. Likewise, input driver 1 2203 and input driver 2 2214 can be accessed to control input device 1 2201 and input device 2 2212, respectively, through the common library 2260 and the Kernel Space 2250. When the first application 2205 calls a first routine in the common library 2260, a tag 2207 indicating first environment 2200 is bound to the first routine in the common library 2260 before executing the first routine for the first application 2205. Likewise, when the second application 2215 calls the first routine in the common library 2260, a tag 2217 indicating second environment 2280 is bound to the first routine in the common library 2260 before executing the first routine for the second application 2215. By doing so, we only need one copy of the common library 2260 to service applications in these two environments. A regulator can be used to balance the calls from applications from these two environments to prevent applications or threads from one particular environment occupying the common library 2260 for a long time. The regulator can be implemented in Kernel Space 2250 or in the user space 2270.

As shown in FIG. 23, there is a demon, such as activity manager 2301 in Android, to manage the operations between applications and the common library 2260, activity manager 2301 keeps a map 2302 for associating each PID (Process ID) of an application to a corresponding TAG indicating which environment the application is running in. For example, the application 1 has a PID 1001 and a TAG value 0 indicating the first environment 2200, and the application 2 has a PID 1003 and a TAG value 1 indicating the second environment 2280.

When the first application 2205 calls the first routine in the common library 2260, the activity manager 2301 associates TAG value 0 indicating the first environment 2200 to the first routine in the common library 2260 by looking up the PID 1001 of the first application to obtain TAG value 0, before executing the first routine for the first application 2205. For example, when the first application 2205 calls the first routine in the common library 2260, the activity manager 2301 writes TAG value 0 in a block of memory containing information for calling the first routine from the first application 2205. Likewise, the activity manager 2301 associates the TAG value 1 indicating the second environment 2280 to the first routine in the common library 2260 by looking up the PID 1003 of the second application to obtain the TAG value 1, before executing the first routine for the second application 2215. For example, when the second application 2215 calls the first routine in the common library 2260, the activity manager 2301 writes the TAG value 1 in a block of memory containing information for calling the first routine from second application 2215.

Foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

1-20. (canceled)

21. A computing device, comprising:
a first video channel and a first input channel, for connecting to a first display device and a first input device for forming a first operating environment, wherein the first operating environment is used for booting the computing device;
a second video channel and a second input channel, for connecting to a second display device and a second input device for forming a second operating environment; and
an operating system;
wherein when a plurality of applications run on top of the operating system, a process identifier (PID) of each of the plurality of applications is respectively associated with a corresponding operating environment selected from a group comprising the first operating environment and the second operating environment, wherein the operating system identifies a corresponding operating environment associated with each application according to the PID of the application so as to associate an execution of the application to a display device in the corresponding operating environment of the application respectively.

22. The computing device according to claim 21, wherein the operating system comprises a common run time library that are shared by the plurality of applications, wherein the common run time library identifies a corresponding operating environment associated with each application according to the PID of the application so as to associate an execution of the application to a display device in the corresponding operating environment of the application respectively.

23. The computing device according to claim 21, wherein each of a first application on the first operating environment and a second application on the second operating environment runs in foreground for inputting data concurrently.

24. The computing device according to claim 21, wherein the operating system comprises a first set of codes for establishing a mapping for associating the process identifier (PID) of each of the plurality of applications to a tag indicating the corresponding operating environment of the application, respectively.

25. The computing device according to claim 24, wherein the mapping is referenced to obtain the tag indicating the corresponding operating environment of the application according to the PID of the application so as to enable the application to display data on a display device in said corresponding operating environment.

26. The computing device according to claim 21, wherein the process identifier (PID) of each of the plurality of applications is respectively associated with a separated tag indicating a corresponding operating environment selected from a group comprising the first operating environment and the second operating environment, so as to enable each application to display data on a display device in said corresponding operating environment respectively.

27. The computing device according to claim 25, wherein the mapping is referenced by a second set of codes of the operating system to obtain a corresponding operating environment of an application according to the PID of the application so as to associate the execution of the application to a device driver associated with the display device in the corresponding operating environment for outputting display data.

28. The computing device according to claim 21, wherein the operating system comprises a first window manager and a second window manager for managing a first desktop on the first display device and a second desktop on the second display device, respectively, wherein each desktop comprises an application running in foreground for inputting data.

29. The computing device according to claim 21, wherein the operating system comprises a window manager for managing a first desktop on a first display device, wherein a first application launched from the first desktop is targeted to run on the second display device.

30. The computing device according to claim 27, wherein the execution of the application sends out a service request to the operating system to output display data, wherein the second set of codes is in a user space of the operating system to intercept the service request of the application, and wherein the second set of codes references the mapping to obtain a corresponding operating environment of the application according to the PID of the application and associates the service request of the application with the corresponding operating environment of the application for outputting display data.

31. The computing device according to claim 27, wherein the execution of the application executes a system call to the operating system to output display data, wherein the second set of codes is in a kernel space to intercept the system call of the application and reference the mapping to link the system call to a device driver associated with the corresponding display device of the application for outputting display data.

32. The computing device according to claim 25, wherein the first set of codes is in a kernel space of the operating system, and wherein the mapping is correlated by embedding the tag of each application into a portion of the PID of the application, wherein the corresponding display device is obtained by referencing said portion of the PID of the application.

33. The computing device according to claim 26, wherein the separated tag associated with each PID is changeable so as to move the application from one operating environment to another operating environment.

34. The computing device according to claim 21, the second video channel comprises at least one of the following hardware resources: a graphic controller, a video frame buffer, a USB interface, a PCIe interface or a wireless transmitter for transmitting display data to each of the at least one second display device.

35. The computing device according to claim 21, wherein each input device is a keyboard, mouse, or a touch pad.

36. The computing device according to claim 21, further comprising a touch panel, wherein the touch panel comprises the first display device and the first input device to form the first operating environment.

37. The computing device according to claim 21, further comprising a first graphic controller and a second graphic controller, wherein the first graphic controller is associated with a first video frame buffer for storing video data for the first video channel and the second graphic controller is associated with a second video frame buffer for storing video data for the second video channel.

38. The computing device according to claim 36, wherein a first application runs on the second display device, and wherein the touch panel is used as an input device for inputting data to the first application.

39. The computing device according to claim 21, wherein the computing device is a mobile phone or a tablet.

40. The computing device according to claim 21, wherein the operating system is based on Android or IOS.
